(19) United States
(12) Patent Application Publication
(10) Pub. No.: US 2014/0183326 A1
(43) Pub. Date: Jul. 3, 2014

(54) HALLOWEEN PUMPKIN/JACK-O-LANTERN DISPLAY STAND

(71) Applicant: Jerry Z. Ples, Mississauga (CA)

(72) Inventor: Jerry Z. Ples, Mississauga (CA)

(21) Appl. No.: 13/731,079

(22) Filed: Dec. 30, 2012

(51) Int. Cl. G09F 19/02

(52) U.S. Cl. CPC G09F 19/02
USPC 248/550; 362/122; 248/425

(57) ABSTRACT

A Halloween pumpkin/jack-o-lantern stand having motorized platform able to rotate jack-o-lantern. A base with legs comprising of front display housing motion sensor which activates several functions including rotating platform, exterior profile lights, interior jack-o-lantern light, moving appendages and audible device. Jack-o-lantern is secured onto platform with extruding prongs.

### BACKGROUND

### Prior Art

The following is a tabulation of some prior art that presently appears relevant:

### U.S. Patents

| Patent Number | Kind Code | Issue Date | Patentee |
|---|---|---|---|
| D, 444, 411 | S | 2001 Jul. 03 | Glaubitz |
| D, 403, 461 | | 1998 Dec. 29 | Friedmann |
| D, 568, 779 | S | 2008 May 13 | Birkmann et al. |
| 8,220,964 | B1 | 2012 Jul. 17 | Martin |

### FIELD OF THE INVENTION

The present invention relates generally to animated display stands and more particularly, to Halloween.

### BACKGROUND OF INVENTION

Traditionally on the day of Halloween people decorate their residence with Halloween novelties and more particularly with a jack-o-lantern. Jack-o-lanterns are typically displayed on the ground where there view is obscured by the viewed angle. By elevating a jack-o-lantern on top a stand, an improved view is provided to the Halloween trick-or-treaters.

Thereafter, inventors created several types of jack-o-lantern stands that increase the profile of the jack-o-lantern by raising the jack-o-lantern off the ground. U.S. patent D444,411 S to Glaubitz (2001) discloses a jack-o-lantern stand that affixes the jack-o-lantern onto a metal humanoid stand several feet off the ground; however, this stand does little to showcase the exterior of the jack-o-lantern without the assistance of an additional source of lighting.

Jack-o-lanterns generally are displayed on Halloween night. In order to illuminate the jack-o-lantern, candles are placed inside the pumpkin cavity. The illumination of the exterior of jack-o-lantern is relatively minuscule as the light eliminating from the jack-o-lantern is projecting outwards and not onto the jack-o-lantern itself. By projecting lights onto the jack-o-lantern, the visibility of the exterior of the jack-o-lantern will be improved.

Several types of artificial jack-o-lantern have been created which illuminate from inside of the pumpkin cavity. U.S. patent Des. 403,461 to Friedmann (1998) discloses an artificial jack-o-lantern with illuminating light inside the cavity. Although projecting light out through the jack-o-lantern, it does little to showcase the exterior profile of the jack-o-lantern.

Jack-o-lanterns are designed to invoke reactions from trick-or-treaters during the festive night of Halloween. Generally, a humanoid face is carved into the pumpkin annotating some human expression thereby creating a sense that the jack-o-lantern is alive. Generally, jack-o-lanterns are displayed motionless on the ground which limits the experience that trick-o-theaters may attain when encountering the novelty. By initiating motion and sound to the jack-o-lantern, the trick-or-treaters may attain an improved experienced.

Several jack-o-lantern decorating kits have been disclosed but lack sounds and motion which may improve the trick-or-treaters experience. U.S. patent D568,779 S to Birkmann et al. (2008), and U.S. Pat. No. 8,220,964 B1 to Martin (2012) are disclosures which decorate the exterior of the jack-o-lantern; however, such decorations do not provide sounds and motion that would animate the jack-o-lantern thereby creating an improved liveliness associated to the jack-o-lantern.

Thus, it would be advantageous to provide a method to elevate a Halloween jack-o-lantern for display to trick-or-treaters during Halloween. It would be additionally advantageous to illuminate the exterior of the jack-o-lantern to allow trick-or-treaters to perceive the exterior of the jack-o-lantern at night. It would be further advantageous to animate the jack-o-lantern with movement and sound to create an improved experience.

### SUMMARY OF THE INVENTION

The present invention is directed toward a jack-o-lantern stand which provides all of the advantages of a conventional jack-o-lantern stand in terms of visibility, yet provides improvements over the disadvantages described prior. As such, the general purpose of the present invention, which will be described subsequently in detail, is to provide an improved jack-o-lantern stand that has the advantages described prior and none of the disadvantages.

The present invention is not limited in its application to the details of construction and to the arrangements of the components set forth in the following description or illustrated in the drawings. The invention is capable of other embodiments and of being carried out in various ways. Also, it is to be understood that the terminology employed herein are for the purpose of description and should not be regarded as limiting.

At least one embodiment of the present invention consists of a jack-o-lantern stand with a platform with extruding prongs designed to pierce into the Halloween pumpkin in order to secure it onto the platform. This in turn will prevent the jack-o-lantern from falling down off the present invention.

It is another embodiment of the present invention consists of a motorized tower designed to rotate the platform. This motion in turn will rotate the jack-o-lantern affixed to the platform thereby animating the jack-o-lantern.

It is another embodiment of the present invention consists of profiling lights designed to illuminate the exterior surface of the jack-o-lantern. Profiling lights are positioned outside of the jack-o-lantern which improve the visualization of the jack-o-lantern.

It is further another embodiment of the present invention consists of a audio device designed to produce sound in the form of a music, voice, and sounds. This in turn improves the animation of the jack-o-lantern affixed to the present invention.

At least one embodiment of the present invention consists of a sensor designed to detect motion. The motion detector may initiate the lights, sounds and motorized platform thereby improving the experience gained by trick-or-treaters.

### BRIEF DESCRIPTION OF THE DRAWINGS

A full and enabling disclosure of the present invention, including the best mode thereof, directed to one of ordinary skilled in the art, is set forth in the specification, which makes reference to the appended drawings, in which:

FIG. 1 is a perspective view of the present invention.

FIG. 2 is a perspective view of the present invention with affixed Halloween pumpkin or jack-o-lantern.

FIG. 3 is a top view of the present invention.

FIG. 4 is a bottom view of the present invention.

FIG. 5 is a front view of the present invention.

FIG. 6 is a front view of the present invention with the screen insert removed.

FIG. 7 is a rear view of the present invention.

FIG. 8 is a rear view of the present invention with the screen insert removed.

FIG. 9 is a side view of the present invention.

FIG. 10 is a side view of the present invention with the screen insert removed.

FIG. 11 is a side view of the platform assembly of the present invention.

FIG. 12 is a side view of the upper base assembly of the present invention.

FIG. 13 is a side view of the lower base assembly of the present invention.

FIG. 14 is a front view of one embodiment of the screen insert with pattern design.

FIG. 15 is a front view of one embodiment of the screen insert with pattern design.

FIG. 16 is a front view of one embodiment of the screen insert with pattern design.

FIG. 17 is a front view of one embodiment of the screen insert with pattern design.

FIG. 18 is perspective view of an alternative embodiment of the present invention.

FIG. 19 is perspective view of an alternative embodiment of the present invention.

FIG. 20 is a schematic view of an embodiment of the present invention.

Drawings-Reference Numerals

| | | | |
|---|---|---|---|
| 10 | Base of closure | 11 | Platform |
| 12 | Screen | 13 | Front Display |
| 14 | Speaker | 15 | Motion Sensor |
| 16 | Profiling Light | 17 | Prongs |
| 18 | Tower | | |

### DETAILED DESCRIPTION OF REPRESENTATIVE EMBODIMENTS

In general, one embodiment of the present invention is directed toward a jack-o-lantern stand consisting of several components designed to showcase a jack-o-lantern. An improved experienced is attained by trick-or-treaters when they are exposed to the jack-o-lantern affixed to the present invention. An improved experience is attained with the motion of the jack-o-lantern in conjunction with lights and sounds in various sequences.

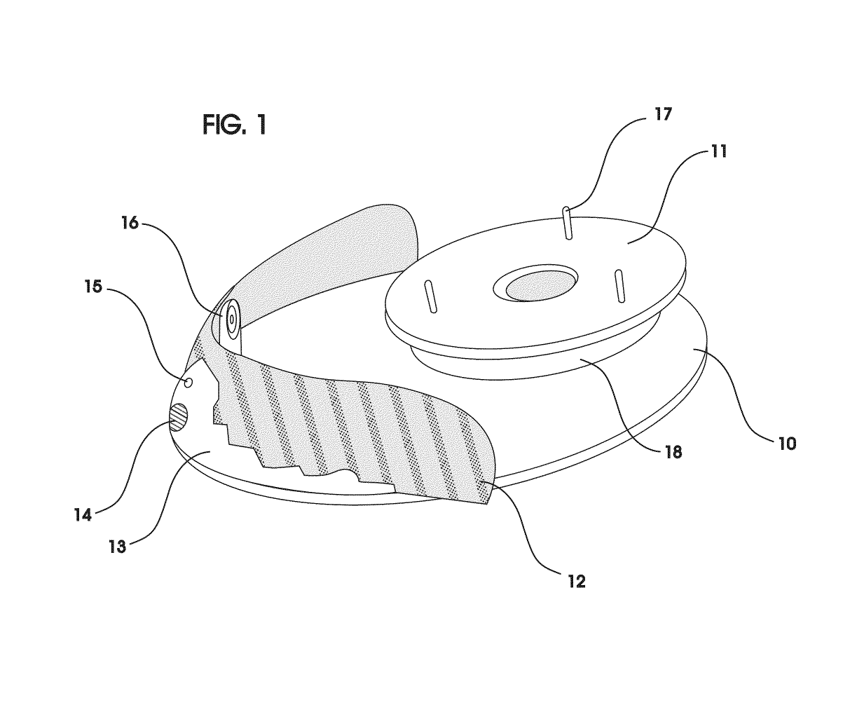

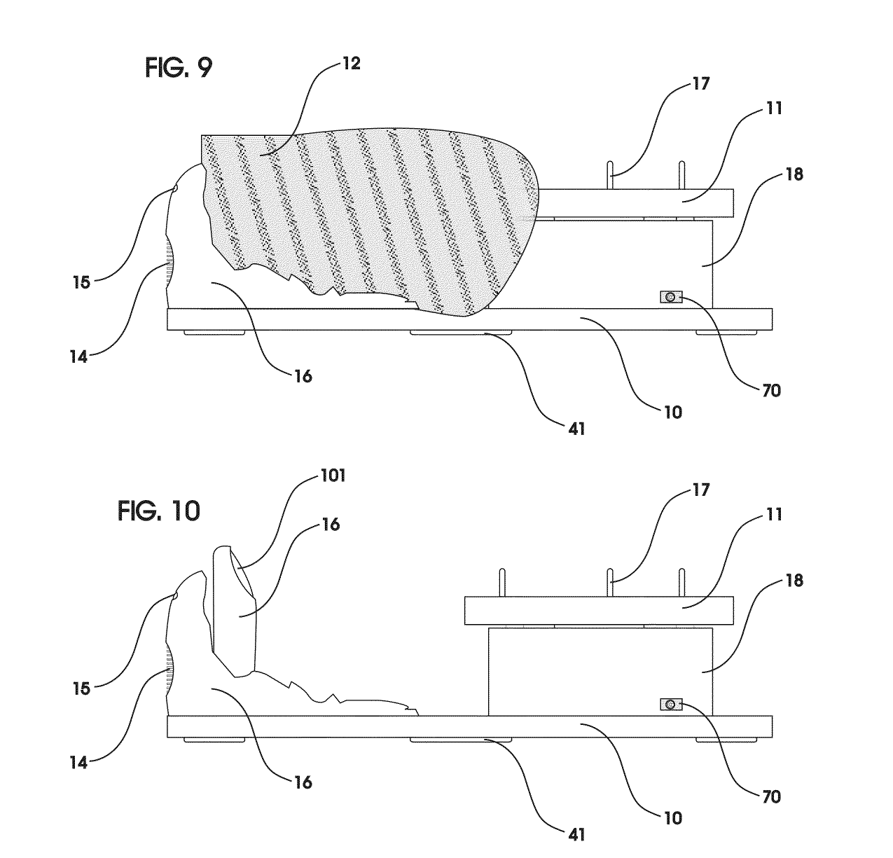

Referring to FIG. 1-20, various embodiments of the jack-o-lantern stand are made in accordance with the present invention are depicted. One embodiment of a perspective view of the present invention is illustrated in FIG. 1, consisting of several components that raise the profile of a Halloween pumpkin. The jack-o-lantern is affixed onto prongs 17 which are connected to platform 11. The platform 11 rotates on top of tower 18 which is connected to the base 10. The base 10 comprises of the front display 13 with integrated speaker 14 and motion sensor 15. The front display 13 contains a slit designed to secure the inserted screen 12. Behind the screen 12 is the profiling light 16 which is affixed to the base 10.

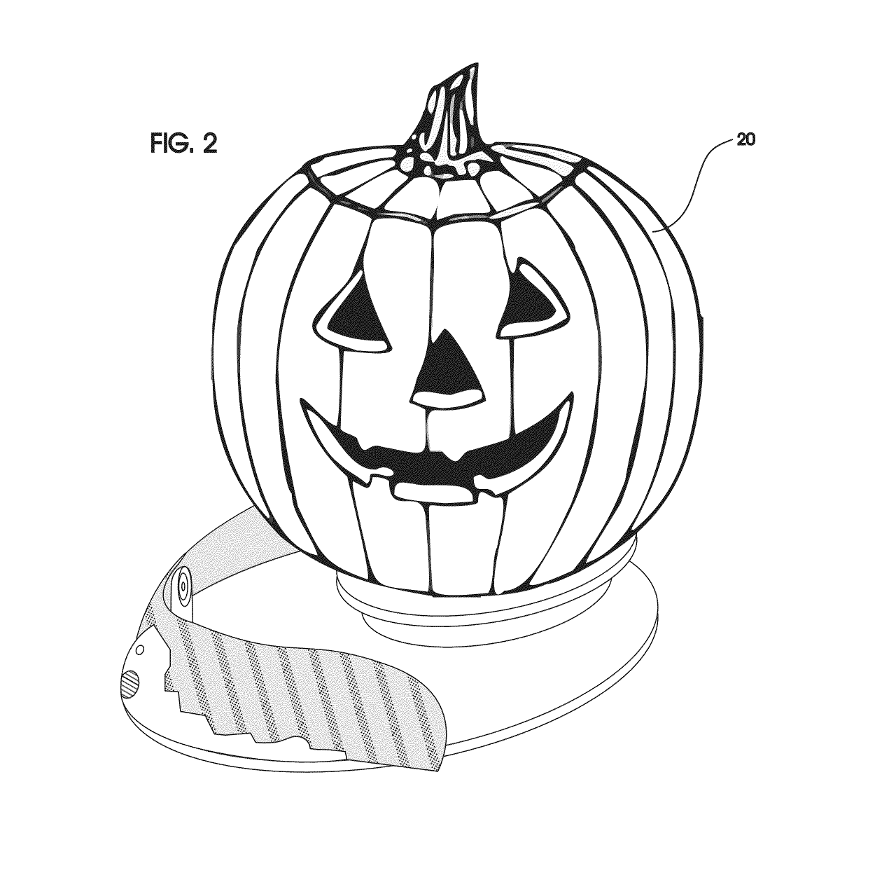

As illustrated in FIG. 2, the jack-o-lantern 20 is perched upon the present invention thereby raising the jack-o-lantern off the ground. This raising of the jack-o-lantern 20 is in part one feature designed to the increase of the profile of the affixed jack-o-lantern 20. As illustrated in FIG. 4 (bottom view), base supports 40 and inner base supports 41 located on the underside of the base 10 stabilize the affixed jack-o-lantern.

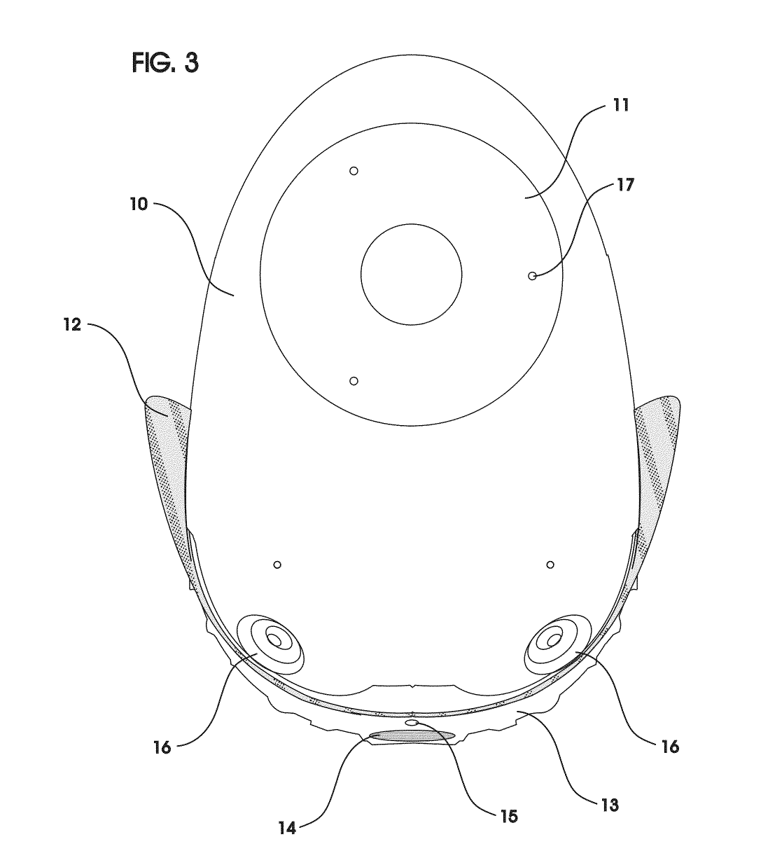

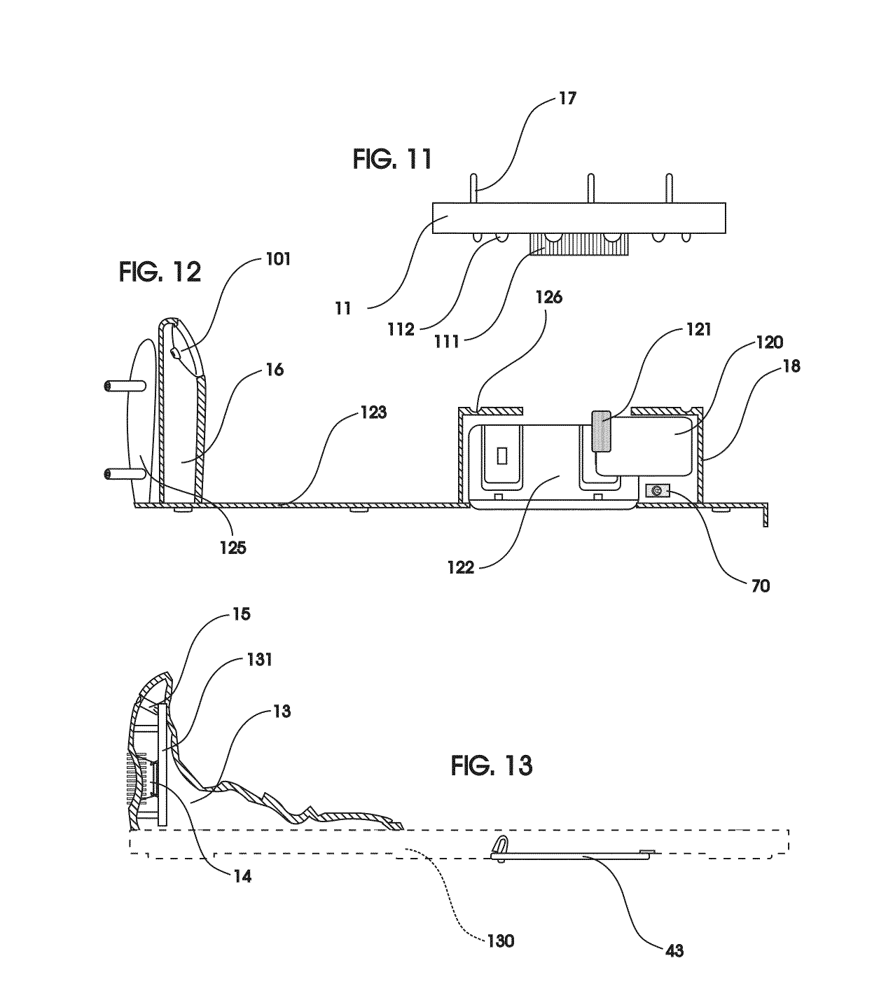

As illustrated in FIG. 3 (top view), one embodiment of the present invention contains profile lights 16 that illuminate the outside of the jack-o-lantern. The profile lights 16 are positioned at an angle as to project light across the surface of the facing jack-o-lantern. The profile lights 16 are positioned apart from one another as to maximize the projected light coverage upon the surface of the jack-o-lantern. FIG. 10 and FIG. 12 illustrate the profile light 16 with light bulb apparatus 101 tilted at an angle.

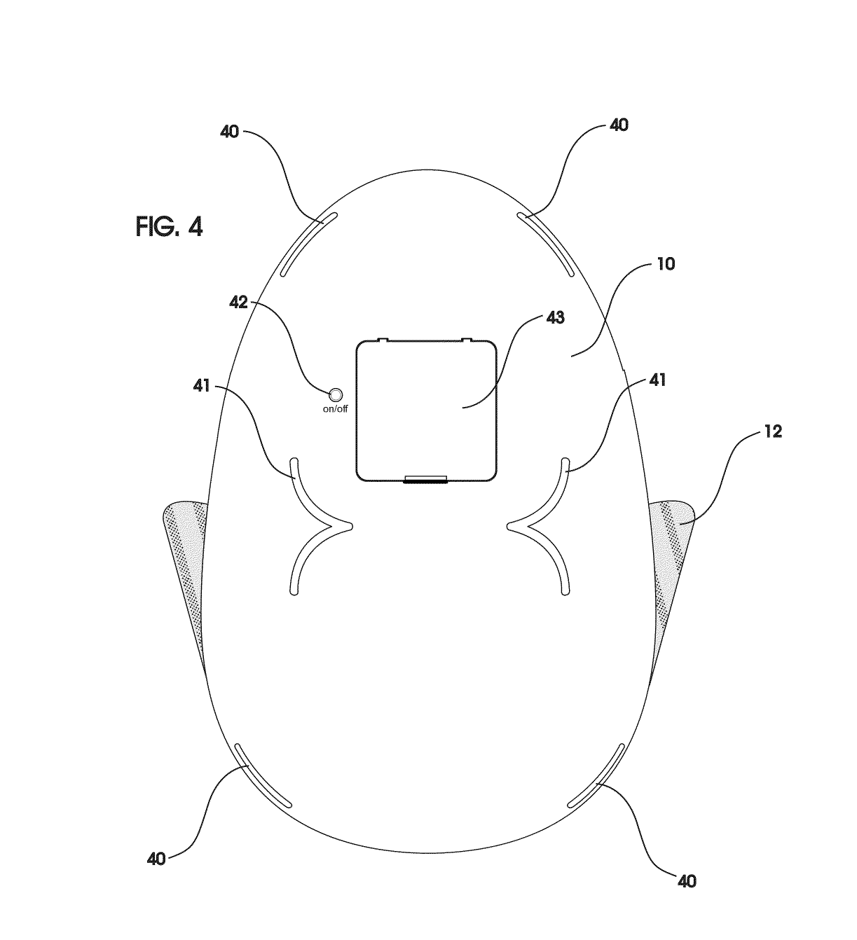

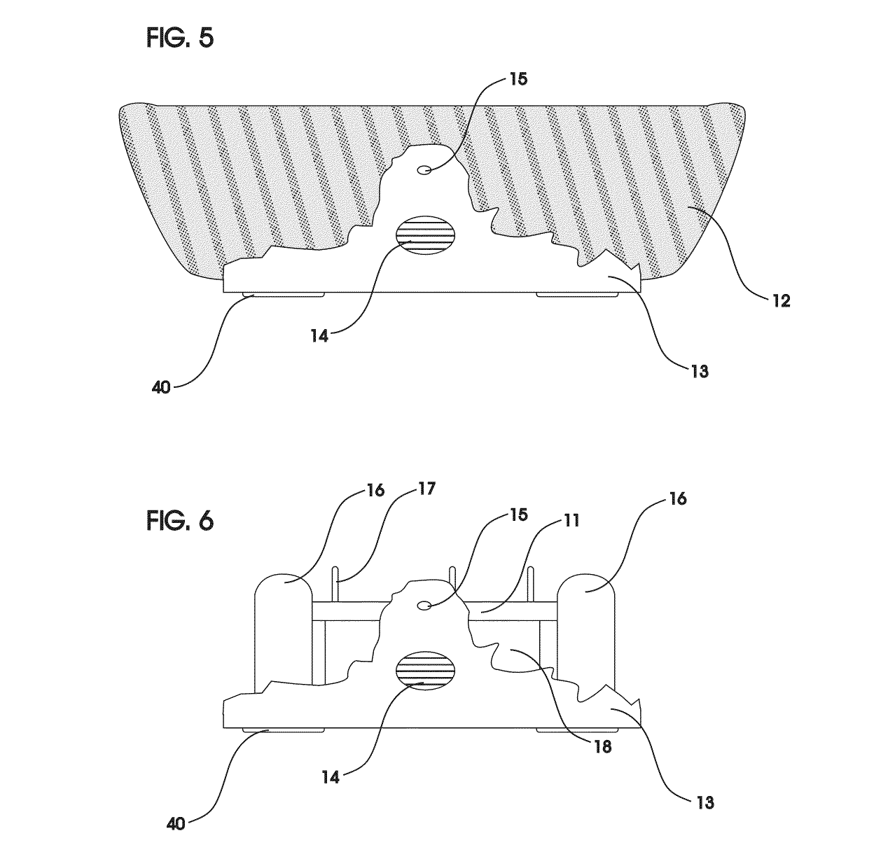

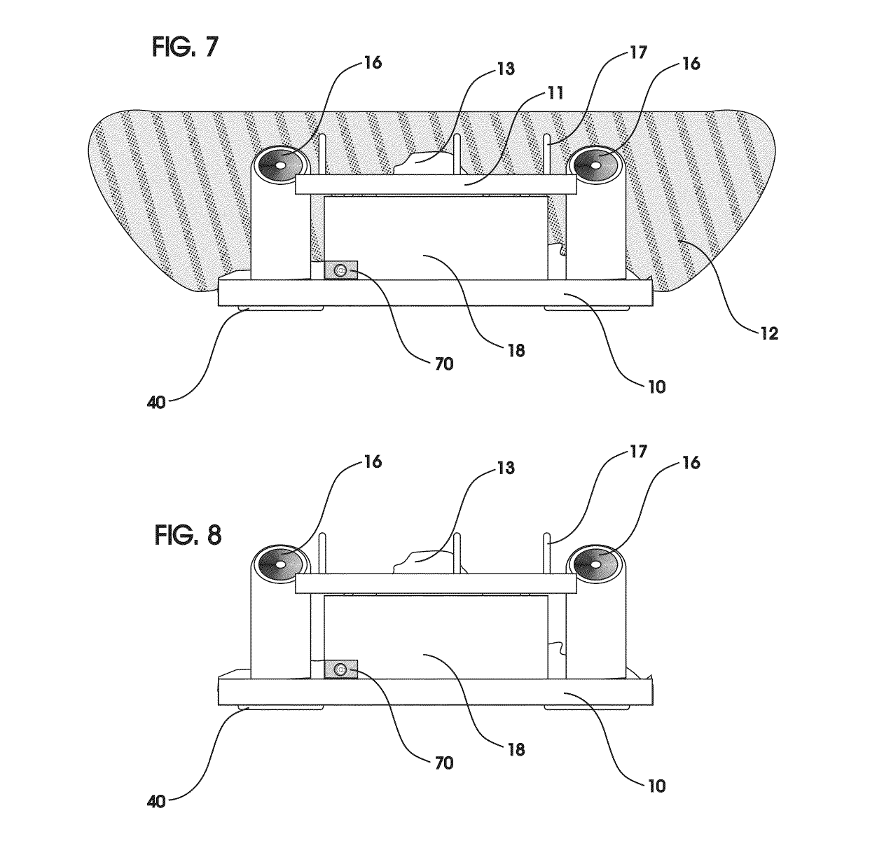

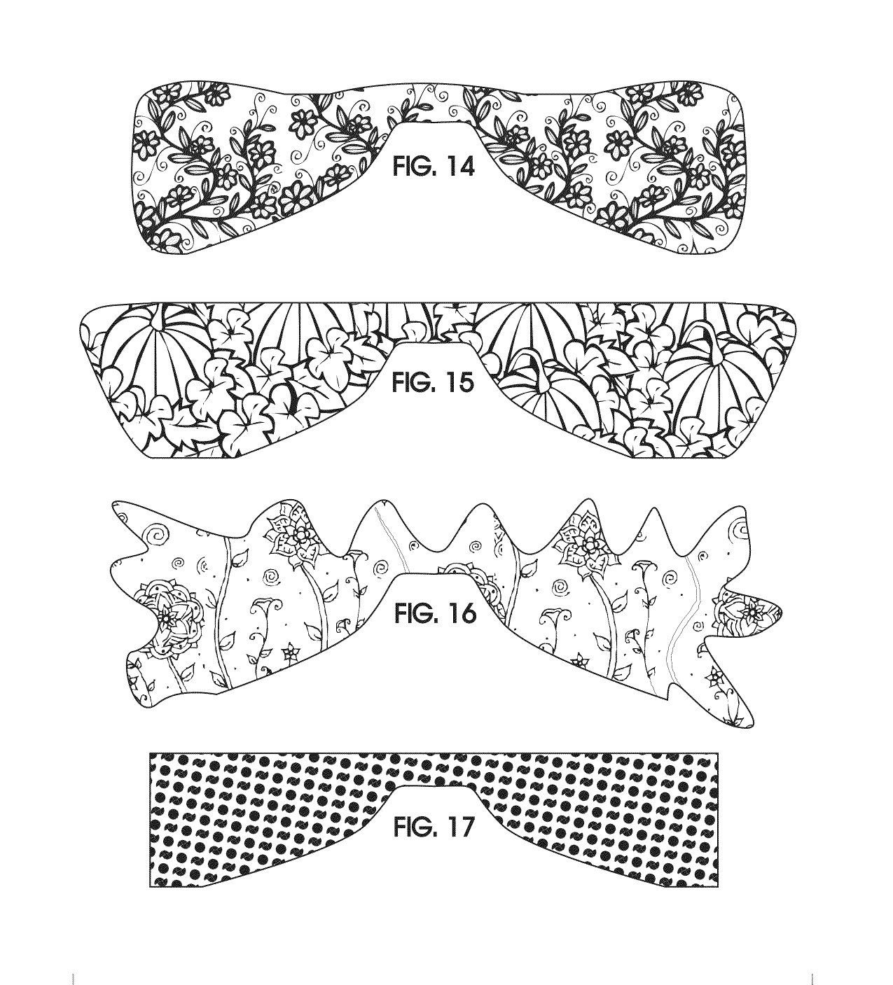

As illustrated in FIG. 5 (front view) and FIG. 6 (front view), the front display 13 contains a slit that secures the screen 12 which generally hides the contents including profiles lights 16, platform 11, and tower 18. The screen may come in different shapes and designs including floral as illustrated in FIG. 14, pumpkin patch as illustrated in FIG. 15, vine pattern as illustrated in FIG. 16, repetitive shapes as illustrated in FIG. 17, and various other patterns designed by those skilled in the art. FIG. 7 (back view) to FIG. 10 (side view) illustrate various embodiments with removable screen 12 affixed and removed. Screen 12 material may consist of, but is not limited to, paper, cardboard, plastics, and the like.

As illustrated in FIG. 12 and FIG. 13, one embodiment of the present invention consists of a motion sensor 15 and a speaker 14 which are powered by batteries housed in the DC battery housing 122 or by AC electricity supplied through AC jack 70. Other elements powered by the present invention may include a motor housed in the gearbox 120. FIG. 4 illustrates the power switch 42 that turns on/off the present invention. DC housing battery cover 43 provides a removable door located on the underside of the base 10, in order to gain access to the DC battery housing 122.

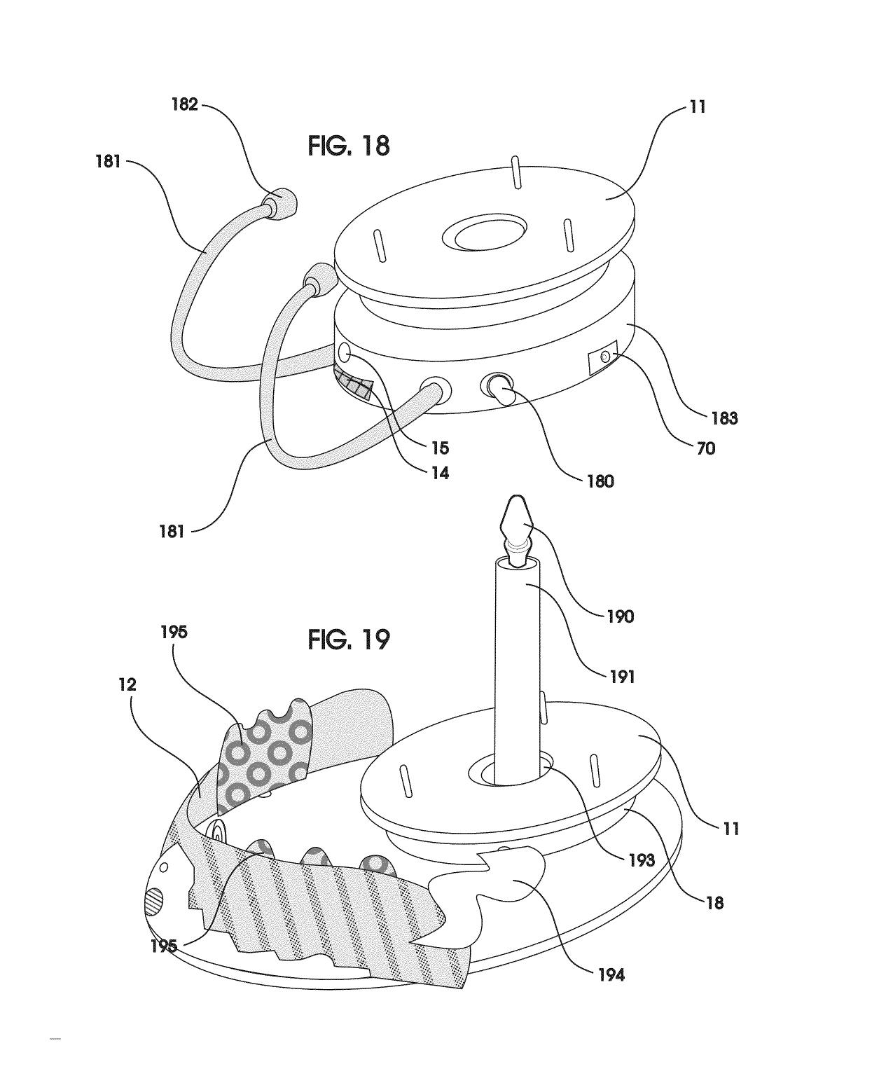

Other alternative embodiments of the present invention are illustrated in FIG. 18 and FIG. 19. FIG. 18 illustrates an embodiment with a short base 183 consisting of profile lights 182 connected to flexing adjustable arms 181. Platform 11 rotates on short base 183 which is actuated by motion sensor 15. The present embodiment is powered through AC jack 70 or by internal power source of batteries housed in short base 183. Motion sensor 15 activates audible through speaker 14, profiles lights 182 and motor that rotates platform 11. FIG. 19 illustrates an embodiment with an inner jack-o-lantern light source 190 connected to tower 18 by a light shaft 191. Light shaft 191 connects to the tower 18 through hole 193. Extruding from the tower 18 is a moving appendage 194 that moves in sequence with the circulating platform 11. Platform 11 may or may not rotate on tower 18. The present embodiment consists of moving screens 195 positioned behind screen 12 that moving in sequence with platform 11.

### OPERATION

An embodiment of the present invention is a jack-o-lantern stand consisting of several components aimed at increasing the profile of the affixed jack-o-lantern. With reference to drawings FIG. 11 through FIG. 13 thereof, the present invention generally consists of a rotating platform 11 consisting of bearings 112 that rest upon the track 126 located on upper portion of tower 18. The platform 11 rotates clockwise or counterclockwise with the assistance of the base gears 121 in conjunction with the platform gears 111.

It is another embodiment of the present invention that consists of an upper base mold 123 and a lower base mold 130. The upper base mold 123 attaches to the lower base mold 130 to form one unit. The present invention consists of a circuit board 131 with the motion sensor 15 and speaker 14 connected thereto. The circuit board 131 is housed between the front display 13 and the front display back panel 125. The circuit board 131 provides the logic to initiate music and voice through the speaker 14, illuminate profile light 16 and rotate the platform 11 when the motion sensor 15 is activated. When a trick-or-treater triggers the motion sensor 15, the present invention activates creating an initial surprise. The present invention may illuminate the affixed jack-o-lantern with various illuminating light patterns and colors. The present invention initiates a voice and music through the speaker 14. The present invention initiates movement of the jack-o-lantern by rotating the platform 11 in various sequences as to create the illusion that the jack-o-lantern in alive.

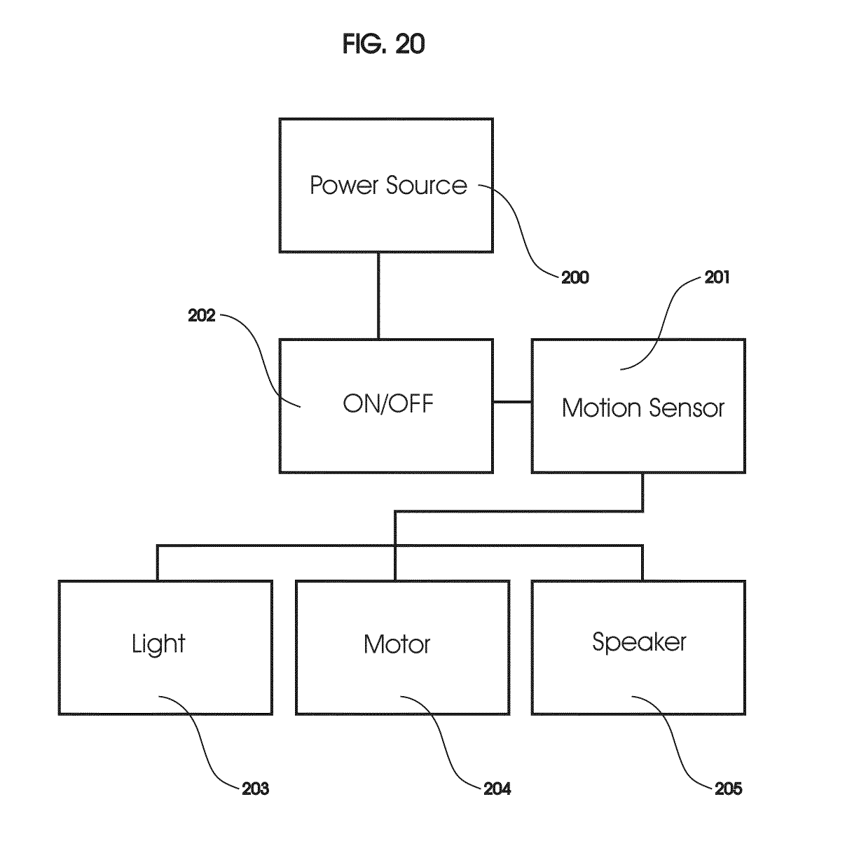

It is another embodiment of the present invention consisting of electrical circuitry. In reference to FIG. 20, a power source 200 is coupled to motion sensor 201 through an actuator 202. Motion sensor 201 selectively turns on which couples power source 200 with light 203, motor 204, and speaker 205. Motion sensor 201 activates a plurality of lights 203, motors 204, and speakers 205.

With respects to the above description then, it is to be realized that the optimum dimensional relationship for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only for the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

1. A Halloween Pumpkin/jack-o-lantern stand for to display a Halloween pumpkin or jack-o-lantern for viewing, comprising:
a base having legs;
a tower;
a platform means for rotating upon said tower;
a motor means of rotating said platform;
a activator connected to the at least one function; and
a power source that responds to the activator and implements the at least one function.

2. The Halloween pumpkin/jack-o-lantern stand in accordance to claim 1, wherein said base comprising a profile light means for illuminating exterior of jack-o-lantern, and said profile light including a colored lens, and a plurality of said profile light means of illuminating in timed intervals.

3. The Halloween pumpkin/jack-o-lantern stand in accordance to claim 1, wherein said base comprising a front display housing a motion sensor, and said motion sensor means of activating the at least one function.

4. The Halloween pumpkin/jack-o-lantern stand in accordance to claim 3, wherein said front display housing a audio device means of playing audible music, voice, and sounds.

5. The Halloween pumpkin/jack-o-lantern stand in accordance to claim 3, wherein said front display housing a screen.

6. The Halloween pumpkin/jack-o-lantern stand in accordance to claim 1, wherein said platform comprising a plurality of prongs means of affixing jack-o-lantern thereof.

7. The Halloween pumpkin/jack-o-lantern stand in accordance to claim 1, wherein said motor means of rotating said platform, and said motor in conjunction with a gear box means of increasing torque.

8. The Halloween pumpkin/jack-o-lantern stand in accordance to claim 1, wherein said tower housing compartment comprising:
a battery compartment;
said motor compartment;
a AC power adaptor;
said gear box.

9. A Halloween Pumpkin/jack-o-lantern stand for to display a Halloween pumpkin or jack-o-lantern for viewing, comprising:
a tower having legs, a platform with a plurality of prongs;
said platform means for rotating upon said tower;
a motor means of rotating said platform;
a activator means for implementing the at least one function.

10. The Halloween pumpkin/jack-o-lantern stand in accordance to claim 9, wherein said tower comprising a plurality of profile light means for illuminating exterior of jack-o-lantern, and said profile light including a colored lens, and said profile light means of illuminating in timed intervals, and said profile light attached to said tower with a adjusting arm.

11. The Halloween pumpkin/jack-o-lantern stand in accordance to claim 9, wherein said tower comprising a motion sensor and a audio device, and said motion sensor means of activating the at least one function;

12. A Halloween Pumpkin/jack-o-lantern stand for to display a Halloween pumpkin or jack-o-lantern for viewing, comprising:
a base having legs;
a tower;
a platform with a plurality of prong;
a activator means for implementing the at least one function;
a motion sensor;
a audible device;
a plurality of profile light with a colored lens means illuminating in timed intervals;
said base comprising a front display housing said motion sensor, said audible device, and a screen;

13. The Halloween pumpkin/jack-o-lantern stand in accordance to claim 12, wherein said tower comprising a interior light, and a plurality of said interior light illuminating in timed sequence.

14. The Halloween pumpkin/jack-o-lantern stand in accordance to claim 12, wherein a plurality of moving appendages attached to said tower and said base.
